(19) United States
(12) Patent Application Publication
(10) Pub. No.: US 2020/0161876 A1
(43) Pub. Date: May 21, 2020

(54) SMART, SELF-CONNECTING MODULAR BATTERY PACKS IN PARALLEL

(71) Applicant: Ten-D Energies, Inc., Mercer Island, WA (US)

(72) Inventors: Jonathan A Dawn, Seattle, WA (US); Mike Ma, Redmond, WA (US); Jerry Gibson, Mercer Island, WA (US)

(21) Appl. No.: 16/192,542

(22) Filed: Nov. 15, 2018

(51) Int. Cl. H02J 7/00; H01M 10/42; H01M 10/44

(52) U.S. Cl. CPC H02J 7/0014; H01M 2010/4271; H01M 10/441; H01M 10/4257

(57) ABSTRACT

A method for combining identical multiple modular battery packs into one multi-pack system using a battery management system (BMS) and an external interface. The method including energizing the system by electrically connecting one or more of the modular battery packs at a time, having the BMS read voltages off each of the modular battery packs to determine when to make an electrical connection of the modular battery packs in a parallel configuration, and selecting which of the modular battery pack electrically connects to the system based on inputs from the external interface that signifies charging or discharging actions of the modular battery packs. Also disclosed is system for combining cells in a modular battery pack.

### BACKGROUND OF THE INVENTION

### Field of the Invention

The present invention is directed generally to battery systems which dynamically connect multi-KWh independent multi-cell packs in parallel under usage.

### Description of the Related Art

The majority of passenger and commercial vehicles that are purely electric carry a fixed energy supply consisting of a single battery pack. There are a number of reasons why vehicle manufacturers decided to go this route, but this design has major limitations. For example, if a cordless power drill had a fixed battery with no way to swap in a new battery, the user would lose productivity waiting for that power drill to recharge at a charging station once the battery becomes depleted. Furthermore, if the worksite is unpowered and the charging station is inconveniently located, more productivity is lost in the overhead such as travel time and swapping a drill bit from the discharged tool to a charged second tool. Having multiple fixed-battery cordless power drills would at least double the cost in capital and once the battery is depleted then the entire tool gets thrown away or recycled because it may have depreciated to a point where it is not economically viable to refurbish and reuse. There have been attempts to make swappable, singular modular battery packs on a grander scale, but because these battery packs are large and expensive, the infrastructure and accounting can be complicated and cumbersome. Another drawback with a single large main battery pack is that it presents a single point of failure without redundancy, increasing the risk of being stranded in case of a failure in the battery pack.

### BRIEF DESCRIPTION OF THE SEVERAL VIEWS OF THE DRAWING(S)

FIG. 1 is an illustration of the interconnection between multiple modular battery packs in a preferred embodiment of the invention.

FIG. 2 is an illustration of the interconnection of components within a single modular battery pack in the preferred embodiment of the invention.

FIG. 3 is a flowchart illustrating the combined logic performed by the preferred embodiment of the invention.

### DETAILED DESCRIPTION OF THE INVENTION

The invention may be embodied in a system where two or more identical battery packs, referred to herein as “modular battery packs,” are physically connected in a parallel configuration within the same system, such as within an electric vehicle or backup power system. These identical modular battery packs must be identical in maximum and minimum voltage with similar charge and discharge characteristics. The energy capacity between each modular battery pack should match closely but does not need to be identical. The modular battery packs will initially be internally electrically disconnected by a relay or other device until an out-of-band signal commands them to become electrically connected. The modular battery pack will include battery management boards (BMBs) that allow communication of the modular battery pack's voltage and other properties to a battery management system (BMS).

One embodiment of the invention is a method and system by which the modular battery pack with the highest voltage is the first to make an electrical connection to the system as calculated and directed by the BMS. In a multi-modular battery pack system having first and second modular battery packs, where the first modular battery pack has the highest voltage, while the system is taking power from the batteries of the first modular battery pack, as soon as the voltage of the first modular battery pack drops to approximately the same voltage as the second modular battery pack (which initially had the second highest voltage), the BMS will command the second modular battery pack to make an electrical connection placing it in parallel with the first modular battery pack. The same sequence will occur for any additional modular battery packs if the system includes more than two. This “top-down voltage matching” technique will carry on until all modular battery packs of the system have made an electrical connection in parallel configuration and to the system will look like one large battery pack.

Another embodiment of the invention is a method and system by which the modular battery pack with the lowest voltage is the first to make an electrical connection to the system as calculated and directed by the BMS. In a multi-modular battery pack system having first and second modular battery packs, where the first modular battery pack has the lowest voltage, while the system is charging the batteries by taking power from an external source such as a wall outlet, as soon as the voltage of the first modular battery pack rises to approximately the same voltage as the second modular battery pack (which initially had the second lowest voltage), the BMS will command the second modular battery pack to make an electrical connection placing it in parallel with the first modular battery pack. The same sequence will occur for any additional modular battery packs if the system includes more than two. This “bottom-up voltage matching” technique will carry on until all modular battery packs of the system have made an electrical connection in parallel and to the system will look like one large battery pack.

Yet another embodiment of the invention is a method and system by which the modular battery pack with the highest voltage has an option to be the first to make an electrical connection to the system as calculated and directed by the BMS. It is not necessary to make any electrical connection with this method. In a multi-modular battery pack system, using the “active balancing” feature of the BMS, the bricks (interchangeably referred to as cells in this context) that are electrically connected in series and governed by a single BMB, and which have the highest total voltage, send power over an isolated pair of wires to charge up individual cells with lower voltages that are governed by other BMBs. As the voltage of the modular battery pack with the highest voltage slowly decreases, the voltage of the modular battery pack with the lowest voltage effectively rises by way of active balancing. There are two parts to the next step. If the decreasing voltage of the modular battery pack formerly with the highest voltage reaches the second-highest voltage quickly, the top two modular battery packs will make an electrical connection in parallel. If the increasing voltage of the modular battery pack formerly with the lowest voltage reaches the second-lowest voltage quickly, the bottom two modular battery packs will make an electrical connection in parallel. This “actively balancing voltage matching” technique will continue until all modular battery packs have made an electrical connection in a parallel configuration and to the system will look like one large battery pack. Once all the modular battery packs have been connected in parallel, it is up to the implementation of the BMS whether or not all of the modular battery packs need to stay connected. Furthermore, the need for making an electrical connection to the system is optional and again depends on implementation of the BMS.

A preferred embodiment of multi-modular battery packs is to combine all methods to cover all charging, discharging, and idle scenarios using the BMS to make calculations based on different data inputs and dictate electrical connections. The preferred embodiment will make integration of modular battery packs into the system safe and simple because the BMS abstracts away modular battery pack data (e.g., SoC) when reporting to the system. This is only one such embodiment of claimed methods and systems; other embodiments based on differing logic, communication protocols, relays, and/or BMS technologies, and energy storage systems making use of some subset of the claimed subject matter, are also possible.

Modular battery packs enable battery swap technology and reduce the complication of charging infrastructure. Using multiple modular battery packs in a single system enables battery swapping as well as increasing reliability, scalability, and upgradability. The mechanics and physical construction of the modular battery packs for battery swapping is up to the manufacturer.

In the preferred embodiment, additional signals to the BMS would be provided to safely make decisions whether or not to electrically connect or disconnect the batteries within the modular battery packs. While there are many parameters that are given to the BMS to accomplish this, those that are particularly of interest include human interaction with the system. In the case of an electric car, for example, the BMS may need to know if the key in the ignition is in the “on” position and if the shifter is in the “park” position. The BMS may also need to know if the charger is plugged in and properly charging the batteries or not. These signals would allow the BMS to correctly distinguish which of these methods to use for electrical connectivity between multiple modular battery packs within an electric car. Other parameters that are of non-human interaction might influence the way the BMS reacts, but this pertains to all BMS and is not unique to the operation of modular battery packs.

Ultimately, the BMS commands an external relay or equivalent device to make the connection from the combination of modular battery packs to the system. Across this external relay, there will be a fixed pre-charge resistor to safely bring up any voltages on the system-side before the external relay closes to make a connection. If the BMS deems the connection is not ready or is unsafe, it will command all relays to disengage, including the ones within each individual modular battery pack.

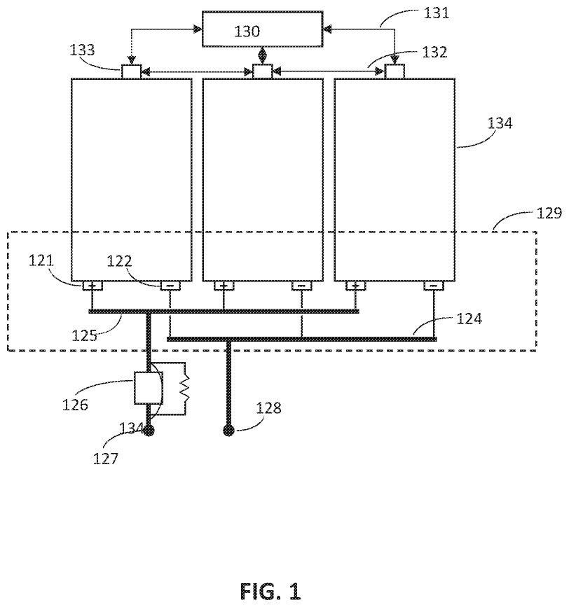

FIG. 1 illustrates an embodiment of the invention using multiple modular battery packs within a system; however, it represents just one of possible embodiment of the invention. The invention includes any electronic embodiment, regardless of communication protocols, relays, BMS, type of cells, or other implementing technology.

For a multi-modular battery pack system, at least two modular battery packs (134) are physically attached to the system. There are low-power connections (131, 132) and high-power connections (121, 122, 123, 124, 125, 127, 128). Communications between a BMS master controller (130) and the BMB within the modular battery pack is through an external interface of the modular battery pack (133) through a wired interface (131). The high-power connections are safely switched on through a fixed pre-charge resistor (134) and a relay or equivalent device (126). Active balancing, the process in which voltages are balanced between modular battery packs, will transfer power over out-of-band connections (132). All the logic to govern how the modular battery packs independently switch on and off, and how the relay (126) operates is finely controlled by the BMS master controller (130).

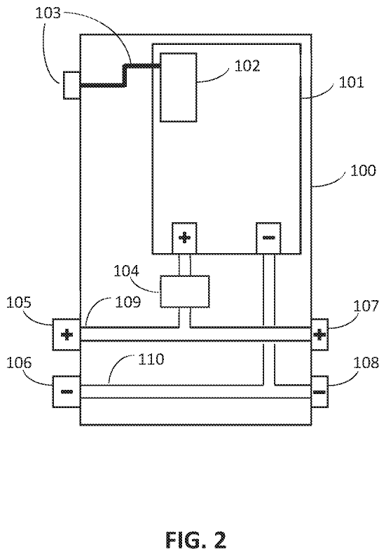

FIG. 2 illustrates an embodiment of the invention within a single modular battery pack; however, it represents just one of possible embodiments of the invention. The invention includes any electronic embodiment, regardless of communication protocols, relays, BMS, type of cells, or other implementing technology.

Within a modular battery pack (100), the main components are one or more battery modules (101), one or more BMBs (102), a single relay or equivalent device (104), a low-power connector (103), high-power connectors (105, 107) for the positive rail input and output (109) that are controlled by the relay, and high-power connectors (106, 108) for the negative rail input and output (110) that are always connected. In this embodiment of the modular battery pack (100), a single BMB (102) connects to a single module (101) that contains more than one battery cell or brick in series. The BMB communicates to the BMS master controller through the low-power connector (103) which is a wired connector and conducts active balancing as well. The wired connector (103) also carries signals for operating the relay (104) that drive the positive rail (109) on or off, and also allows the transfer of energy between modular battery packs for active balancing.

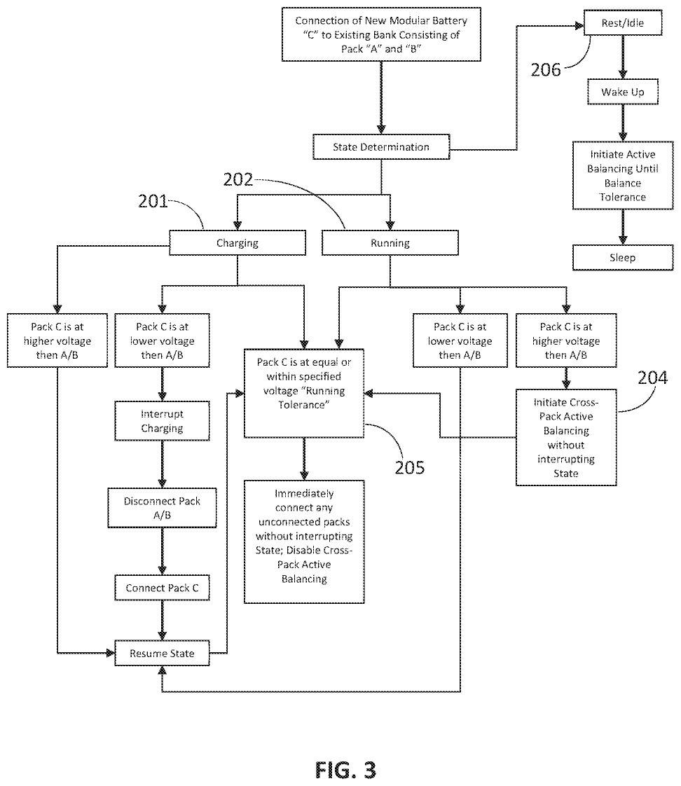

FIG. 3 is a flowchart illustrating the combined logic implemented by the preferred embodiment. With this invention, a system can contain one or more modular battery packs.

For each modular battery pack that is connected to the system, the BMS detects it as a new event and starts from the top of the flowchart. The main steps of the method used by the system are charging (201), running (202), and idle (206). In the case of hot-swapping a new modular battery pack into the system, there is no need to shut down the system while it is drawing power from the batteries, but merely activate balancing (204) between modular battery packs when the system goes into charging or idle stages. This is different from the scenario when the system is charging the batteries, where the system will stop charging first if the new modular battery pack that gets swapped in has a lower voltage. The “Running Tolerance” is approximately 0.1V per cell, so for example a 18s modular battery pack will have a 1.8V difference between packs.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for combining identical multiple modular battery packs into one multi-pack system using a battery management system (BMS) and an external interface, the method comprising:
energizing the system by electrically connecting one or more of the modular battery packs at a time;
having the BMS read voltages off each of the modular battery packs to determine when to make an electrical connection of the modular battery packs in a parallel configuration; and
selecting which of the modular battery pack electrically connects to the system based on inputs from the external interface that signifies charging or discharging actions of the modular battery packs.

2. The method of claim 1, further comprising:
based on input from the external interface that the system needs to draw power from the batteries when all of the modular battery packs are electrically disconnected, the BMS sends a command to the modular battery pack with the highest voltage to make an electrical connection to the system;
as the system is discharging the first connected battery pack, the BMS sends a command to electrically connect the second-highest-voltage modular battery pack in parallel with the first connected modular battery pack; and
sequentially connecting the next-highest-voltage modular battery pack to the already connected modular battery packs until all of the modular battery packs are connected or until the input from the external interface otherwise indicates.

3. The method of claim 2, further comprising:
based on input from the external interface that the system will take power from an external source and charge the batteries when all of the modular battery packs are electrically disconnected, the BMS sends a command to the modular battery pack with the lowest voltage to make an electrical connection to the system;
as the system is charging the first connected battery pack, the BMS sends a command to electrically connect the second-lowest-voltage modular battery pack in parallel with the first connected modular battery pack; and
continuing to sequentially connect the already connected modular battery packs with the next-lowest-voltage battery pack until all the modular battery packs are connected or until the input from the external interface otherwise indicates.

4. The method of claim 3, further comprising:
based on input from the external interface that the system will be idle when all modular battery packs are electrically disconnected, the BMS starts active balancing between a first module with the highest-voltage of a first modular battery pack and one or more cells or bricks within the lowest-voltage modular battery pack with the lowest voltage;
if the highest voltage of the first module decreases quicker than a preselected decrease rate, the BMS sends a command to electrically connect the second-highest-voltage modular battery pack in parallel with the first modular battery pack; and
if the lowest voltage of the first module rises quicker that a preselected increase rate, the BMS sends a command to electrically connect the second-lowest voltage-modular battery pack in parallel with the lowest-voltage modular battery pack.

5. The method of claim 4, further comprising:
the BMS electrically disconnecting all of the modular battery packs from the system if needed to connect to the system by implementation, and/or disconnect all modular battery packs from each other.

6. A system for combining cells in a modular battery pack and attaching modular battery packs together, the system comprising:
a plurality of cells having identical electrical characteristics in each modular battery pack;
a plurality of interchangeable modular battery packs having overall physical dimensions;
means for the modular battery packs making physical external electrical connections, wherein said means is rendered immutable by the use of two pairs of high current battery terminals on either side of the modular battery pack in symmetric fashion;
means for electrically connecting and disconnecting the plurality of cells from inside the modular battery pack externally in response to an out-of-bands signal, wherein said means is rendered immutable by the use of a relay or equivalent device that is powered internally or externally and the signal can be actively or passively controlling the relay;
means for the battery to provide data externally whether or not the modular battery packs are electrically connected or disconnected, wherein said means is rendered immutable by the use of one or more BMBs connected to every cell within each modular battery pack and transferring data externally;
means for the modular battery packs transferring power for active balancing, separately from the main charging and discharging mechanisms of the system, wherein said means is rendered immutable by use of active balancing circuitry within the modular battery pack which sends energy externally from one modular battery pack to another;
means for controlling high-power electrical connection and disconnection between all the modular battery packs and external, wherein said means is rendered immutable by the use of a relay or equivalent device that is commanded by a signal from the BMS; and
means for making gentle and safe electrical connections externally, through a fixed pre-charge resistor placed across the relay or equivalent device for controlling high-power electrical connections and disconnections.
